(19) United States
(12) Patent Application Publication
(10) Pub. No.: US 2020/0023825 A1
(43) Pub. Date: Jan. 23, 2020

(54) VEHICLE BRAKE SYSTEM USING ELECTRIC PARKING BRAKE IN FAILED BOOST CONDITIONS

(71) Applicant: ZF Active Safety US Inc., Livonia, MI (US)

(72) Inventors: Craig Mitchell, South Lyon, MI (US); Greg Timm, White Lake, MI (US); Patrick Harman, Canton, MI (US); Deron Littlejohn, West Bloomfield, MI (US); Seth Bunin, Swartz Creek, MI (US)

(73) Assignee: ZF Active Safety US Inc., Livonia, MI (US)

(21) Appl. No.: 16/488,767

(22) PCT Filed: Feb. 28, 2018
(86) PCT No.: PCT/US2018/020294

§ 371 Date: Aug. 26, 2019

Related U.S. Application Data
(60) Provisional application No. 62/464,957, filed on Feb. 28, 2017.
(60) Provisional application No. 62/611,906, filed on Dec. 29, 2017.
(60) Provisional application No. 62/611,909, filed on Dec. 29, 2017.
(60) Provisional application No. 62/611,916, filed on Dec. 29, 2017.

(51) Int. Cl. B60T 13/58; B60T 7/04; B60T 13/12; B60T 13/74; B60T 1/06; B60T 8/17; B60T 13/62

(52) U.S. Cl. CPC B60T 13/588; B60T 7/042; B60T 13/12; B60T 13/746; B60T 2270/404; B60T 8/17; B60T 13/62; B60T 2270/402; B60T 1/065

(57) ABSTRACT

A brake system for a vehicle comprises a driver operable brake pedal coupled to control a brake pressure generating unit to supply hydraulic brake pressure to front and rear hydraulically actuated wheel brakes, and wherein the rear wheel brakes are also configured to be electrically actuated; a sensor arrangement for monitoring the driver's braking intent; the brake system operable in a first mode wherein the front and rear brakes are both hydraulically actuated, and a second mode wherein the front brakes are hydraulically actuated and the rear brakes are electrically actuated, the rear brakes include a caliper assembly including brake pads operable to engage a brake rotor to brake the vehicle, the caliper assembly including a hydraulic actuating mechanism and an electric actuating mechanism, a control connected to the sensor arrangement for operating the electric actuating mechanism to actuate the rear brakes as a function of the driver's braking demand.

### CROSS REFERENCES TO RELATED APPLICATIONS

This application claims priority to, and the benefit of, U.S. Provisional Application Ser. No. 62/464,957, filed Feb. 28, 2017, U.S. Provisional Application Ser. No. 62/611,906, filed Dec. 29, 2017, U.S. Provisional Application Ser. No. 62/611,909, filed Dec. 29, 2017, and U.S. Provisional Application Ser. No. 62/611,916, filed Dec. 29, 2017, the full disclosures of which are incorporated herein by reference.

### BACKGROUND OF THE INVENTION

This invention relates in general to hydraulically boosted brake systems and in particular to a method of operation of an electric parking brake for use with such a hydraulically boosted brake system.

An example of a prior art hydraulically boosted brake system which uses an electric parking brake (EPB) as a backup in the event of a failure is disclosed in U.S. Pat. No. 6,598,943 to Harris, the disclosure of which is hereby incorporated by reference in entirety herein. In the prior art system, there is provided a vehicle braking system comprising an electro-hydraulic braking means and an electric parking brake means.

The electro-hydraulic braking means is of the type which has a normal, boosted operating mode in which boosted hydraulic fluid pressure is applied by braking devices—e.g., disc brakes—at the vehicle wheels in proportion to a driver's braking demand to provide service braking. The braking demand is sensed electronically at a service brake pedal. If the boosted operating mode with boost should fail, the system operates in a push through mode to provide service braking. In the push through mode, service braking is provided by hydraulic fluid pressure applied to the braking devices by way of a master cylinder mechanically coupled to the service brake pedal.

The electric parking brake uses the braking devices to provide a parking brake function. In the event that the boosted operating mode has failed, for example boost has failed or is otherwise unavailable, it is arranged that operation of the service brake pedal by the driver also causes operation of the electric parking brake to supplement the braking provided by the push through mode.

In the system of U.S. Pat. No. 6,598,943, the push through mode operates only on the braking devices for the front vehicle wheels while the electric parking brake operates only on the rear vehicle wheels. However, because the electric parking brake is not designed for the application of precisely known braking torque, there is still some risk that use of the electric parking brake to supplement the push through mode may cause instability by locking the rear vehicle wheels. U.S. Pat. No. 6,598,943 addresses this problem by arranging the system layout such that wheel speed data is available to a parking brake electronic control unit. It is then possible to use the technique of electronic brake apportioning (EBA) so that, if the rear wheels tend to lock, the electric parking brake is released and then reapplied at a lower torque level. Alternatively, the electric parking brake can be controlled in a manner similar to an antilock brake system (ABS)—i.e., by cyclically applying and releasing the electric parking brake in response to the wheel speed data.

However, in the push through mode, there is significant travel of the service brake pedal before the electric parking brake provides the desired braking force. The driver may find the significant travel of the service brake pedal to be alarming. Also, limiting the push through mode to operate only on the braking devices on the front vehicle wheels requires isolation of hydraulic brake circuits to the braking devices for the rear wheels. However, isolating the hydraulic brake circuits to the braking devices for the rear wheels may result in air being drawn into the hydraulic circuits when the electric parking brake operates. Thus, there is a need for improved operation of the electric parking brake when the electric parking brake is operated to supplement the push through mode of the hydraulically boosted system in the event of a failed boost condition.

### SUMMARY OF THE INVENTION

This invention relates to a method of operation of an electric parking brake for use as a backup in a hydraulically boosted brake system that is configured to provide four wheel push through in the event of a failed boost condition. According to the invention, the electric parking brake is activated to provide for a brake torque overlay at the wheels where the electric parking brake is mounted. The brake torque overlay is a function of the driver's operation of the vehicle service brake pedal.

According to one embodiment, a vehicle brake system for a vehicle may comprise, individually and/or in combination, one or more of the following features: a brake pedal operable by a vehicle driver and coupled to control a brake pressure generating unit to supply hydraulic brake pressure to front and rear hydraulically actuated wheel brakes, and wherein the rear wheel brakes are also configured to be electrically actuated; a sensor arrangement for monitoring the driver's braking intent; the brake system operable in a first mode wherein the front and rear brakes are both hydraulically actuated, and a second mode wherein the front brakes are hydraulically actuated and the rear brakes are electrically actuated, the rear brakes include a caliper assembly including brake pads operable to engage a brake rotor to brake the vehicle, the caliper assembly including a hydraulic actuating mechanism and an electric actuating mechanism, and a control connected to the sensor arrangement for operating the electric actuating mechanism to actuate the rear brakes as a function of the driver's braking demand.

According to this embodiment, the sensor arrangement monitors brake pedal travel and the electric actuating mechanism is operated as a function of the brake pedal travel.

According to this embodiment, the sensor arrangement monitors a brake pedal force applied by the driver and/or a hydraulic pressure in the unit, and wherein the electric actuating mechanism is operated as a function of the pedal force and/or the hydraulic pressure.

According to this embodiment, the electric operating mechanism is operated according to a predetermined actuating time curve that is a function of the pedal force and/or hydraulic pressure.

According to this embodiment, the control is responsive to an initial braking command to operate the electric actuating mechanism such that the pads are moved to a disc contact position.

According to this embodiment, the initial braking command is a function of the travel of the brake pedal when initially operated by the vehicle driver.

According to this embodiment, the vehicle includes a vehicle throttle operable by the vehicle driver to control propulsion of the vehicle, and wherein the initial braking command is a function of the driver's release rate of the throttle.

According to this embodiment, the brake system includes at least one inlet or isolation valve connected to supply pressure to the hydraulic actuating mechanism, and wherein the control is operable to actuate the isolation valve when the system is in the second mode to hydraulically isolate the front brakes from the rear brakes.

According to this embodiment, the brake system includes at least one outlet or dump valve connected to relieve pressure from the hydraulic actuating mechanism, and wherein the control is operable to actuate the dump valve during at least a portion of the time the electric actuating mechanism is being operated to prevent hydraulic lock and/or vacuum pull in the hydraulic actuating mechanism.

According to this embodiment, the brake system is a brake by wire system, and wherein the first mode defines a brake by wire, boosted mode, and the second mode defines a manual push through, failed boost mode.

According to this embodiment, the electric actuating mechanism also forms part of an electric parking brake system.

Other advantages of this invention will become apparent to those skilled in the art from the following detailed description of the preferred embodiment, when read in light of the accompanying drawings.

### BRIEF DESCRIPTION OF THE DRAWINGS

FIG. 1 is a schematic view of a service brake system and an electric parking brake for a vehicle.

FIG. 2 is a section view of a wheel brake of the service brake system of FIG. 1 with one of the electric parking brakes of FIG. 1.

FIG. 3 is a flow chart of a first embodiment of a control method for the electric parking brake of FIG. 1.

FIGS. 4A and 4B are a table and graph for the control method of FIG. 3.

FIG. 5 is a flow chart of a clearance reduction method for use with the control method of FIG. 3.

FIG. 6 is a flow chart of a pressure release method for use with the control method of FIG. 3.

FIG. 7 is a schematic flow chart of the control method of FIG. 3 incorporating the methods of the FIGS. 5 and 6 as well as the table and graph of FIGS. 4A and 4B.

FIG. 8 is a flow chart of a second embodiment of a control method for the electric parking brakes of FIG. 1.

FIG. 9 is a state diagram for the electric parking brake of FIG. 1 during the control method of FIG. 8.

FIGS. 10A and 10B are a first table and graph for the control method of FIG. 8.

FIGS. 11A and 11B are a second table and graph for the control method of FIG. 8.

FIG. 12 is a schematic flow chart of the control method of FIG. 8 incorporating the methods of the FIGS. 5 and 6 as well as the tables and graphs of FIGS. 10A-11B.

### DETAILED DESCRIPTION OF THE PREFERRED EMBODIMENT

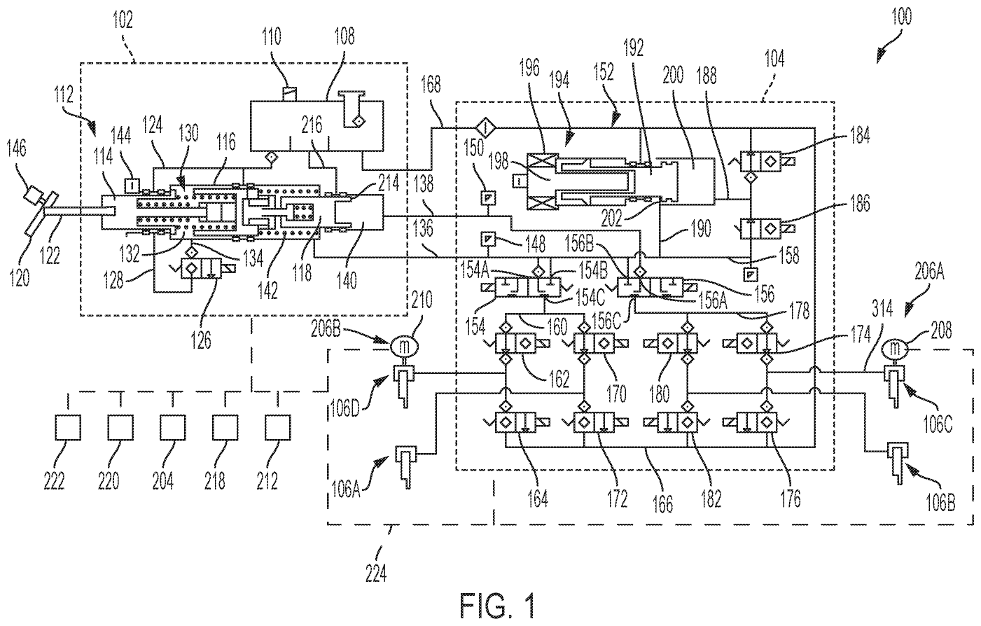

Referring now to the drawings, there is schematically illustrated in FIG. 1 a service brake system, indicated generally at 100, that incorporates the features of the present invention. The service brake system 100 may be as disclosed by U.S. Pat. No. 9,321,444 to Ganzel, the disclosure of which is hereby incorporated by reference in entirety herein.

The service brake system 100 is a hydraulic boost braking system. Boosted fluid pressure is utilized to apply service braking forces for the service brake system 100. Preferably, the fluid pressure is hydraulic brake fluid pressure. The service brake system 100 may suitably be used on a ground vehicle such as an automotive vehicle having four wheels with a wheel brake associated with each wheel. Furthermore, the service brake system 100 can be provided with other braking functions such as antilock braking (AB) and other slip control features to effectively brake the vehicle.

The service brake system 100 generally includes a first block or brake pedal unit assembly, indicated by broken lines 102, and a second block or hydraulic control unit, indicated by broken lines 104. The various components of the service brake system 100 are housed in the brake pedal unit assembly 102 and the hydraulic control unit 104. The brake pedal unit assembly 102 and the hydraulic control unit 104 may include one or more blocks or housings made from a solid material, such as aluminum, that has been drilled, machined, or otherwise formed to house the various components. Fluid conduits may also be formed in the housings to provide fluid passageways between the various components. The housings of the brake pedal unit assembly 102 and the hydraulic control unit 104 may be single structures or may be made of two or more parts assembled together.

As schematically shown, the hydraulic control unit 104 is located remotely from the brake pedal unit assembly 102 with hydraulic lines hydraulically coupling the brake pedal unit assembly 102 and the hydraulic control unit 104. Alternatively, the brake pedal unit assembly 102 and the hydraulic control unit 104 may be housed in a single housing. It should also be understood that the grouping of components as illustrated in FIG. 1 is not intended to be limiting and any number of components may be housed in either of the housings.

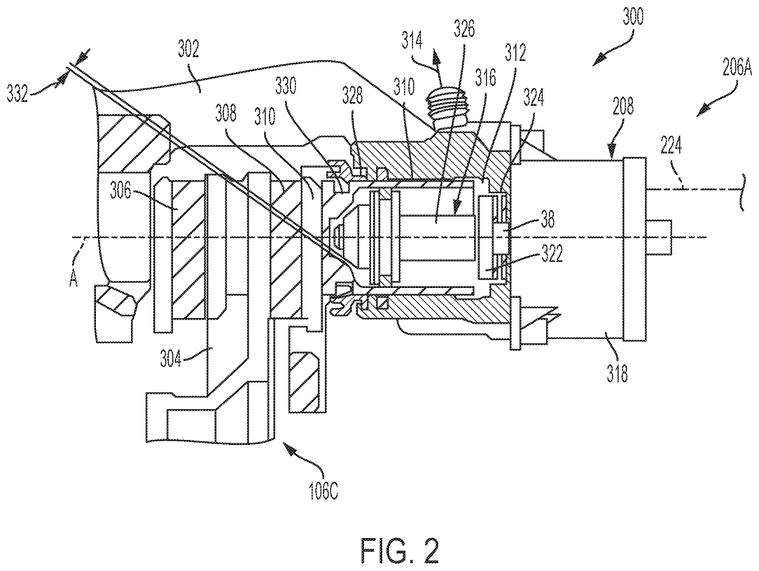

The brake pedal unit assembly 102 cooperatively acts with the hydraulic control unit 104 for actuating first, second, third, and fourth wheel brakes, indicated generally at 106A, 106B, 106C, and 106D, respectively, to provide service braking for the vehicle. The first, second, third, and fourth wheel brakes 106A, 106B, 106C, and 106D, respectively, can be any suitable wheel brake structure operated by the application of pressurized brake fluid. As will be discussed with respect to FIG. 2, the first, second, third, and fourth wheel brakes 106A, 106B, 106C, and 106D, respectively, each include a brake piston 310 and caliper assembly 302 (both shown in FIG. 2) mounted on the vehicle. The brake piston 310 and caliper assembly 302 engage a brake rotor 304 (shown in FIG. 2) that rotates with an associated vehicle wheel to effect braking of the vehicle wheel.

The first, second, third, and fourth wheel brakes 106A, 106B, 106C, and 106D, respectively, can be associated with any combination of front and rear wheels of the vehicle in which the service brake system 100 is installed. For example, for a vertically split system, the first and fourth wheel brakes 106A and 106D, respectively, may be associated with the wheels on the same axle. For a diagonally split brake system, the first and second wheel brakes 106A and 106B, respectively, may be associated with the front wheels. Preferably, the first and second wheel brakes 106A and 106B, respectively, are for front wheels of the vehicle and the third and fourth wheel brakes 106C and 106D, respectively, are for rear wheels of the vehicle.

The brake pedal unit assembly 102 includes a fluid reservoir 108 for storing and holding hydraulic fluid for the service brake system 100. The hydraulic fluid within the fluid reservoir 108 may be held generally at atmospheric pressure or other pressures if so desired. The service brake system 100 may include a fluid level sensor 110 for detecting the fluid level of the reservoir. The fluid level sensor 110 may be helpful in determining whether a leak has occurred in the service brake system 100.

The brake pedal unit assembly 102 includes a brake pedal unit (BPU), indicated generally at 112. It should be understood that the structural details of the components of the brake pedal unit 112 illustrate only one example of a brake pedal unit 112. The brake pedal unit 112 further includes an input piston 114, a primary piston 116, and a secondary piston 118. A service brake pedal, indicated schematically at 120 in FIG. 1, is coupled to a first end of the input piston 114 via an input rod 122. The input rod 122 can be coupled directly to the input piston 114 or can be indirectly connected through a coupler (not shown). The brake pedal unit 112 is in a “rest” position as shown in FIG. 1. In the “rest” position, the service brake pedal 120 has not been depressed by a driver of the vehicle.

The brake pedal unit 112 is in fluid communication with the fluid reservoir 108 via a conduit 124. The brake pedal unit 112 is also in fluid communication with a simulation valve 126 via a conduit 128. The simulation valve 126 may be a cut off valve which may be electrically operated. The simulation valve 126 may be mounted in a housing of the brake pedal unit 112 or may be remotely located therefrom. The brake pedal unit 112 houses various components defining a pedal simulator assembly, indicated generally at 130, and a fluid simulation chamber 132. The fluid simulation chamber 132 is in fluid communication with a conduit 134 which in turn is in fluid communication with the simulation valve 126.

As discussed above, the brake pedal unit 112 includes the primary and secondary pistons 116 and 118, respectively. The primary and secondary pistons 116 and 118, respectively, are generally coaxial with one another. A primary output conduit 136 is in fluid communication with the primary piston 116. A secondary output conduit 138 is in fluid communication with the secondary piston 118. As will be discussed in detail below, rightward movement of the primary and secondary pistons 116 and 118, respectively, as viewing FIG. 1, provides pressurized fluid out through the primary and secondary output conduits 136 and 138, respectively. Rightward movement of the secondary piston 118, as viewing FIG. 1, also causes a buildup of pressure in a secondary output pressure chamber 140. The secondary output pressure chamber 140 is in fluid communication with the secondary output conduit 138 such that pressurized fluid is selectively provided to the hydraulic control unit 104. Rightward movement of the primary piston 116, as viewing FIG. 1, causes a buildup of pressure in a primary output pressure chamber 142. The primary output pressure chamber 142 is in fluid communication with the primary output conduit 136 such that pressurized fluid is selectively provided to the hydraulic control unit 104.

The service brake system 100 may further include a travel sensor, schematically shown at 144 in FIG. 1, for producing a pedal travel signal that is indicative of a length or percentage of travel of the input piston 114. The length of travel of the input piston 114 is also indicative of pedal travel of the service brake pedal 120. The service brake system 100 may also include a switch 146 for producing a signal for actuation of a brake light and to provide a signal indicative of movement of the input piston 114. The service brake system 100 may further include sensors such as first and second pressure transducers 148 and 150, respectively, for monitoring the pressure in the primary and secondary output conduits 136 and 138, respectively.

The service brake system 100 further includes a source of pressure in the form of a plunger assembly, indicated generally at 152. The plunger assembly 152 is a brake pressure generating unit. As will be explained in detail below, the service brake system 100 uses the plunger assembly 152 to provide a desired pressure level to the first, second, third, and fourth wheel brakes 106A, 106B, 106C, and 106D, respectively, during a normal boosted brake apply. Fluid from the first, second, third, and fourth wheel brakes 106A, 106B, 106C, and 106D, respectively, may be returned to the plunger assembly 152 or diverted to the fluid reservoir 108.

The service brake system 100 further includes a first isolation valve 154 and a second isolation valve 156 (or, commonly referred to in the art as switching valves or base brake valves). The first and second isolation valves 154 and 156, respectively, may be solenoid actuated three way valves. The first and second isolation valves 154 and 156, respectively, are generally operable to two positions, as schematically shown in FIG. 1.

The first isolation valve 154 has a first port 154A in selective fluid communication with the primary output conduit 136, which itself is in fluid communication with the primary output pressure chamber 142. A second port 154B of the first isolation valve 154 is in selective fluid communication with a boost conduit 158. A third port 154C of the first isolation valve 154 is in fluid communication with a conduit 160, which itself is selectively in fluid communication with the first and fourth wheel brakes 106A and 106D, respectively.

The second isolation valve 156 has a first port 156A in selective fluid communication with the secondary output conduit 138, which itself is in fluid communication with the secondary output pressure chamber 140. A second port 156B of the second isolation valve 156 is in selective fluid communication with the boost conduit 158. A third port 156C of the second isolation valve 156 is in fluid communication with a conduit 178, which itself is selectively in fluid communication with the second and third wheel brakes 106B and 106C, respectively.

The service brake system 100 further includes various valves—i.e., a slip control valve arrangement—for permitting controlled braking operations, such as ABS, traction control, vehicle stability control, and regenerative braking blending. A first set of valves includes a first apply or inlet valve 162 and a first dump or outlet valve 164 in fluid communication with the conduit 160 for cooperatively supplying brake fluid received from the boost valves to the fourth wheel brake 106D, and for cooperatively relieving pressurized brake fluid from the fourth wheel brake 106D to a first reservoir conduit 166 in fluid communication with a second reservoir conduit 168 to the fluid reservoir 108. A second set of valves includes a second apply or inlet valve 170 and a second dump or outlet valve 172 in fluid communication with the conduit 160 for cooperatively supplying brake fluid received from the boost valves to the first wheel brake 106A, and for cooperatively relieving pressurized brake fluid from the first wheel brake 106A to the first reservoir conduit 166. A third set of valves includes a third apply or inlet valve 174 and a third dump or outlet valve 176 in fluid communication with the conduit 178 for cooperatively supplying brake fluid received from the boost valves to the third wheel brake 106C, and for cooperatively relieving pressurized brake fluid from the third wheel brake 106C to the first reservoir conduit 166. A fourth set of valves includes a fourth apply or inlet valve 180 and a fourth dump or outlet valve 182 in fluid communication with the conduit 178 for cooperatively supplying brake fluid received from the boost valves to the second wheel brake 106B, and for cooperatively relieving pressurized brake fluid from the second wheel brake 106B to the first reservoir conduit 166.

As stated above, the service brake system 100 includes the source of pressure in the form of the plunger assembly 152 to provide a desired pressure level to the first, second, third, and fourth wheel brakes 106A, 106B, 106C, and 106D, respectively. The service brake system 100 further includes a venting valve 184 and a pumping valve 186 which cooperate with the plunger assembly 152 to provide boost pressure to the boost conduit 158 for actuation of the first, second, third, and fourth wheel brakes 106A, 106B, 106C, and 106D, respectively. The venting valve 184 and the pumping valve 186 may be solenoid actuated valves movable between open positions and closed positions. In the closed positions, the venting valve 184 and the pumping valve 186 may still permit flow in one direction as schematically shown as check valves in FIG. 1. The venting valve 184 is in fluid communication with the second reservoir conduit 168 and a first output conduit 188 is in fluid communication with the plunger assembly 152. A second output conduit 190 is in fluid communication between the plunger assembly 152 and the boost conduit 158.

The plunger assembly 152 includes a piston 192 connected to a ball screw mechanism, indicated generally at 194. The ball screw mechanism 194 is provided to impart translational or linear motion of the piston 192 along an axis in both a forward direction (rightward as viewing FIG. 1), and a rearward direction (leftward as viewing FIG. 1). The ball screw mechanism 194 includes a motor 196 rotatably driving a screw shaft 198. The motor 196 may include a sensor for detecting a rotational position of the motor 196 and/or ball screw mechanism 194. The rotational position is indicative of a linear position of the piston 192. The plunger assembly 152 also includes a first pressure chamber 200 and a second pressure chamber 202.

As stated above, the brake pedal unit assembly 102 includes a simulation valve 126. As schematically shown in FIG. 1, the simulation valve 126 may be a solenoid actuated valve. The simulation valve 126 includes a first port and a second port. The first port is in fluid communication with the conduit 134, which itself is in fluid communication with the fluid simulation chamber 132. The second port is in fluid communication with the conduit 128, which itself is in fluid communication with the fluid reservoir 108 via the conduit 124. The simulation valve 126 is movable between a first position restricting the flow of fluid from the fluid simulation chamber 132 to the fluid reservoir 108, and a second position permitting the flow of fluid between the fluid reservoir 108 and the fluid simulation chamber 132. The simulation valve 126 is in the first, or normally closed, position when not actuated such that fluid is prevented from flowing out of the fluid simulation chamber 132 through conduit 128, as will be explained in detail below.

The service brake system 100 is further provided with a system status sensor 204 that provides a system status for the service brake system 100. For example, the system status sensor 204 may provide the system status that the plunger assembly 152 has failed or is otherwise unavailable, or that the service brake system 100 is operating in a push through or manual apply mode (the push through mode will be discussed further).

The vehicle further has first and second electric parking brakes (EPB's), indicated generally at 206A and 206B, respectively. The general structures and operation of the first and second EPB's 206A and 206B, respectively, are conventional in the art. Thus, only those portions of the first and second EPB's 206A and 206B, respectively, which are necessary for a full understanding of this invention will be explained in detail. For example, the first and second EPB's 206A and 206B, respectively, may be as disclosed by U.S. Pat. No. 8,844,683 to Sternal et al., the disclosure of which is hereby incorporated by reference in entirety herein. Discussion of one of the first or second EPB's 206A or 206B, respectively, applies to the other of the first or second EPB's 206A or 206B, respectively, unless otherwise noted.

As illustrated, the first EPB 206A is provided at the third wheel brake 106C and the second EPB 206B is provided at the fourth wheel brake 106D. Preferably, when the first EPB 206A is provided at the third wheel brake 106C and the second EPB 206B is provided at the fourth wheel brake 106D, the third and fourth wheel brakes 106C and 106D, respectively, are on a rear axle of the vehicle. Alternatively, there may be more or fewer than the first and second EPB's 206A and 206B, respectively, provided for the vehicle. Alternatively, the third and fourth wheel brakes 106C and 106D, respectively, may be other than on the rear axle or on the same axle.

Provided for the first EPB 206A is a first actuator 208. Similarly, a second actuator 210 is provided for the second EPB 206B. Preferably, the first and second actuators 208 and 210, respectively, are electric motors. The first actuator 208 may be operated to selectively support the brake piston of the third wheel brake 106C against the brake rotor 304 mounted on an associated wheel. Similarly, the second actuator 210 may be operated to selectively support the brake piston of the fourth wheel brake 106D against the brake rotor 304 on another associated wheel. As such, the first and second EPB's 206A and 206B, respectively, are motor on caliper (MOC) style EPB's and the third and fourth wheel brakes 106C and 106D, respectively, may be electrically actuated. Normal operation of the first and second EPB's 206A and 206B, respectively, provides a parking brake function for the vehicle.

In addition to the system status sensor 204, a brake electronic control unit (ECU) 212, a parking brake electronic control unit (ECU) 218, a parking brake manual control 220, and a throttle input sensor 222 are provided. The brake ECU 212, parking brake ECU 218, parking brake manual control 220, and throttle input sensor 222 will be discussed further. The system status sensor 204, brake ECU 212, parking brake ECU 218, parking brake manual control 220, and throttle input sensor 222 are connected by a data bus 224. The data bus 224 also connects the brake pedal unit assembly 102 and the first and second EPB's 206A and 206B, respectively. The throttle input sensor 222 measures a throttle input that controls propulsion of the vehicle.

The following is a description of normal operation of the service brake system 100 in a hydraulically boosted brake by wire mode. Alternatively, the service brake system may be hydraulically boosted system but without a brake by wire mode. FIG. 1 illustrates the service brake system 100 and the brake pedal unit 112 in the rest position. In this condition, the driver is not depressing the service brake pedal 120. Also in the rest condition, the simulation valve 126 may be energized or not energized. During a typical braking condition, the service brake pedal 120 is depressed by the driver. The service brake pedal 120 is coupled to the travel sensor 144 for producing the pedal travel signal that is indicative of the length of travel of the input piston 114 and providing the pedal travel signal to the brake ECU 212.

The brake ECU 212 may include a microprocessor. The brake ECU 212 receives various signals, processes signals, and controls the operation of various electrical components of the service brake system 100 in response to the received signals. The control module can be connected to various sensors such as pressure sensors, travel sensors, switches, wheel speed sensors, and steering angle sensors. The brake ECU 212 may also be connected to an external module (not shown) for receiving information related to yaw rate, lateral acceleration, longitudinal acceleration of the vehicle such as for controlling the service brake system 100 during vehicle stability operation. Additionally, the brake ECU 212 may be connected to the instrument cluster for collecting and supplying information related to warning indicators such as an ABS warning light, brake fluid level warning light, and traction control/vehicle stability control indicator light.

During normal braking operations (normal boost apply braking operation) the plunger assembly 152 is operated to provide boost pressure to the boost conduit 158 for actuation of the first, second, third, and fourth wheel brakes 106A, 106B, 106C, and 106D, respectively. Under certain driving conditions, the brake ECU 212 communicates with a powertrain control module (not shown) and other additional braking controllers of the vehicle to provide coordinated braking during advanced braking control schemes (e.g., antilock braking (AB), traction control (TC), vehicle stability control (VSC), and regenerative brake blending). During a normal boost apply braking operation, the flow of pressurized fluid from the brake pedal unit 112 generated by depression of the service brake pedal 120 is diverted into the internal pedal simulator assembly 130. The simulation valve 126 is actuated to divert fluid through the simulation valve 126 from the fluid simulation chamber 132 to the fluid reservoir 108 via the conduits 124, 128, and 134. Prior to movement of the input piston 114, as shown in FIG. 1, the fluid simulation chamber 132 is in fluid communication with the fluid reservoir 108 via the conduit 124.

During the duration of the normal braking mode, the simulation valve 126 remains open permitting the fluid to flow from the fluid simulation chamber 132 to the fluid reservoir 108. The fluid within the fluid simulation chamber 132 is non-pressurized and is under very low pressure, such as atmospheric or low reservoir pressure. This non-pressurized configuration has an advantage of not subjecting the sealing surfaces of the pedal simulator to large frictional forces from seals acting against surfaces due to high pressure fluid. In conventional pedal simulators, the piston(s) are under increasingly high pressures as the brake pedal is depressed subjecting them to large frictional forces from the seals, thereby adversely affecting the pedal feel.

Also during the normal boost apply braking operation, the first and second isolation valves 154 and 156, respectively, are energized to a secondary position to prevent the flow of fluid from the primary and secondary output conduits 136 and 138, respectively, through the first and second isolation valves 154 and 156. Fluid is prevented from flowing from the first port 154A to the third port 154C and from the first port 156A to the third port 156C. Thus, the fluid within the primary and secondary output pressure chambers 142 and 140, respectively, of the brake pedal unit 112, is fluidly locked which generally prevents the primary and secondary pistons 116 and 118, respectively, from moving further.

More specifically, during the initial stage of the normal boost apply braking operation, movement of the input rod 122 causes movement of the input piston 114 in a rightward direction, as viewing FIG. 1. Initial movement of the input piston 114 causes movement of the primary piston 116. Movement of the primary piston 116 causes initial movement of the secondary piston 118 due to a mechanical connection therebetween. Also, during initial movement of the secondary piston 118, fluid is free to flow from the secondary pressure chamber 140 to the fluid reservoir 108 via the conduits 214 and 216 until the conduit 155 has moved sufficiently rightward to close the conduit 214.

After the primary and secondary pistons 116 and 118, respectively, stop moving, the input piston 114 continues to move rightward, as viewing FIG. 1, upon further movement by the driver depressing the service brake pedal 120. Further movement of the input piston 114 compresses the various springs of the pedal simulator assembly 130, thereby providing a feedback force to the driver of the vehicle.

During normal braking operations (normal boost apply braking operation), while the pedal simulator assembly 130 is being actuated by depression of the service brake pedal 120, the plunger assembly 152 can be actuated by the electronic control unit to provide actuation of the first, second, third, and fourth wheel brakes 106A, 106B, 106C, and 106D, respectively. Actuation of the first and second isolation valves 154 and 156, respectively, to their secondary positions prevents the flow of fluid from the primary and secondary output conduits 136 and 138, respectively, through the first and second isolation valves 154 and 156, respectively, and isolates the brake pedal unit 112 from the first, second, third, and fourth wheel brakes 106A, 106B, 106C, and 106D, respectively. The plunger assembly 152 may provide “boosted” or higher pressure levels to the first, second, third, and fourth wheel brakes 106A, 106B, 106C, and 106D, respectively compared to the pressure generated by the brake pedal unit 112 by the driver depressing the service brake pedal 120. Thus, the service brake system 100 provides for assisted braking in which boosted pressure is supplied to the first, second, third, and fourth wheel brakes 106A, 106B, 106C, and 106D, respectively, during a normal boost apply braking operation, which helps reduce the force required by the driver acting on the service brake pedal 120.

To actuate the first, second, third, and fourth wheel brakes 106A, 106B, 106C, and 106D, respectively via the plunger assembly 152 when in its rest position, as shown in FIG. 1, the electronic control unit energizes the venting valve 184 to its closed position, as shown in FIG. 1. The venting valve 184 in the closed position prevents fluid from venting to the fluid reservoir 108 by flowing from the first output conduit 188 to the second reservoir conduit 168. The pumping valve 186 is de-energized to its open position, as shown in FIG. 1, to permit flow of fluid through the pumping valve 186.

The electronic control unit actuates the motor 196 in a first rotational direction to rotate the screw shaft 198 in the first rotational direction. Rotation of the screw shaft 198 in the first rotational direction causes the piston 192 to advance in the forward direction (rightward as viewing FIG. 1). Movement of the piston 192 causes a pressure increase in the first pressure chamber 200 and fluid to flow out of the first pressure chamber 200 and into the first output conduit 188. Fluid can flow into the boost conduit 158 via the open pumping valve 186. Note that fluid is permitted to flow into the second pressure chamber 202 via the second output conduit 190 as the piston 192 advances in the forward direction.

Pressurized fluid from the boost conduit 158 is directed into the conduits 160 and 178 through the first and second isolation valves 154 and 156, respectively. The pressurized fluid from the conduits 160 and 178 can be directed to the first, second, third, and fourth wheel brakes 106A, 106B, 106C, and 106D, respectively, through opened first, second, third, and fourth apply valves 162, 170, 174, and 180, respectively, while the first, second, third, and fourth dump valves 164, 172, 176, and 182, respectively, remain closed. When the driver releases the service brake pedal 120, the pressurized fluid from the first, second, third, and fourth wheel brakes 106A, 106B, 106C, and 106D, respectively, may back drive the ball screw mechanism 194 moving the piston 192 back to its rest position. Under certain circumstances, it may also be desirable to actuate the motor 196 of the plunger assembly 152 to retract the piston 192 and withdrawing the fluid from the first, second, third, and fourth wheel brakes 106A, 106B, 106C, and 106D, respectively. During a forward stroke of the plunger assembly 152, the pumping valve 186 may be in its open position or held closed.

During a braking event, the electronic brake ECU 212 can also selectively actuate the first, second, third, and fourth apply valves 162, 170, 174, and 180, respectively, and the first, second, third, and fourth dump valves 164, 172, 176, and 182, respectively, to provide a desired pressure level to the fourth, first, third, and second wheel brakes 106D, 106A, 106C, and 106B, respectively.

In some situations, the piston 192 of the plunger assembly 152 may reach its full stroke length when stroked forwardly and additional boosted pressure is still desired to be delivered to the first, second, third, and fourth wheel brakes 106A, 106B, 106C, and 106D, respectively. The plunger assembly 152 is a dual acting plunger assembly such that it is configured to also provide boosted pressure to the boost conduit 158 when the piston 192 is stroked rearwardly. This has the advantage over a conventional plunger assembly that first requires its piston to be brought back to its rest or retracted position before it can again advance the piston to create pressure within a single pressure chamber.

If the piston 192 has reached its full stroke, for example, and additional boosted pressure is still desired, the pumping valve 186 is energized to its closed check valve position. The venting valve 184 may be de-energized to its open position. Alternatively, the venting valve 184 may be left energized in its closed position to permit fluid flow through its check valve during a pumping mode. The electronic control unit actuates the motor 196 in a second rotational direction opposite the first rotational direction to rotate the screw shaft 198 in the second rotational direction. Rotation of the screw shaft 198 in the second rotational direction causes the piston 192 to retract or move in the rearward direction (leftward as viewing FIG. 1). Movement of the piston 192 causes a pressure increase in the second pressure chamber 202 and fluid to flow out of the second pressure chamber 202 and into the second output conduit 190. Note that fluid is permitted to flow into the first pressure chamber 200 via the second reservoir conduit 168 and first output conduit 188 as the piston 192 moves rearwardly or in its return stroke.

Pressurized fluid from the boost conduit 158 is directed into the conduits 160 and 178 through the first and second isolation valves 154 and 156, respectively. The pressurized fluid from the conduits 160 and 178 can be directed to the first, second, third, and fourth wheel brakes 106A, 106B, 106C, and 106D, respectively, through the opened first, second, third, and fourth apply valves 162, 170, 174, and 180, respectively, while first, second, third, and fourth dump valves 164, 172, 176, and 182, respectively, remain closed. In a similar manner as during a forward stroke of the piston 192, the brake ECU 212 can also selectively actuate the first, second, third, and fourth apply valves 162, 170, 174, and 180, respectively, and the first, second, third, and fourth dump valves 164, 172, 176, and 182, respectively, to provide a desired pressure level to the first, second, third, and fourth wheel brakes 106D, 106A, 106C, and 106B, respectively.

In the event of a loss of electrical power to portions of the service brake system 100 (such that the normal, boosted operating mode is inoperative or otherwise unavailable) the service brake system 100 provides for operation in a manual push through or manual apply mode such that the brake pedal unit 112 can supply relatively high pressure fluid to the primary output conduit 136 and the secondary output conduit 138. During an electrical failure, the motor 196 of the plunger assembly 152 might cease to operate, thereby failing to produce pressurized hydraulic brake fluid from the plunger assembly 152. The first and second isolation valves 154 and 156, respectively, will shuttle (or remain) in their positions to permit fluid flow from the primary and secondary output conduits 136 and 138, respectively, to the first, second, third, and fourth wheel brakes 106A, 106B, 106C, and 106D, respectively. The simulation valve 126 is shuttled to its closed position to prevent fluid from flowing out of the fluid simulation chamber 132 to the fluid reservoir 108. Thus, moving the simulation valve 126 to its closed position hydraulically locks the fluid simulation chamber 132 and traps fluid therein. During the manual push through apply, the primary and secondary pistons 116 and 118, respectively, will advance rightward pressurizing the secondary and primary chambers 140 and 142, respectively. Fluid flows from the secondary and primary chambers 140 and 142, respectively, into the primary and secondary output conduits 136 and 138, respectively, to actuate the first, second, third, and fourth wheel brakes 106A, 106B, 106C, and 106D, respectively, as described above.

During the manual push through apply, initial movement of the input piston 114 forces spring(s) of the pedal simulator to start moving the primary and secondary pistons 116 and 118, respectively. After further movement of the input piston 114, in which the fluid within the fluid simulation chamber 132 is trapped or hydraulically locked, further movement of the input piston 114 pressurizes the fluid simulation chamber 132. This causes movement of the primary piston 116, which also causes movement of the secondary piston 118 due to pressurizing of the primary output pressure chamber 142.

As shown in FIG. 1, the input piston 114 has a smaller diameter than the diameter of the primary piston 116. Since the hydraulic effective area of the input piston 114 is less than the hydraulic effective area of the primary piston 116, the input piston 114 may axially travel more in the right-hand direction as viewing FIG. 1 than the primary piston 116. An advantage of this configuration is that although a reduced diameter effective area of the input piston 114 compared to the larger diameter effective area of the primary piston 116 requires further travel, the force input by the driver's foot is reduced. Thus, less force is required by the driver acting on the service brake pedal 120 to pressurize the first, second, third, and fourth wheel brakes 106A, 106B, 106C, and 106D, respectively, compared to a system in which the input piston 114 and the primary piston 116 have equal diameters.

In another example of a failure or fault condition of the service brake system 100, the hydraulic control unit 104 may fail as discussed above and furthermore one of the primary and secondary output pressure chambers 142 and 140, respectively, may be reduced to zero or reservoir pressure, such as failure of a seal or a leak in one of the primary or secondary output conduits 136 or 138, respectively. The mechanical connection of the primary and secondary pistons 116 and 118, respectively, prevents a large gap or distance between the primary and secondary pistons 116 and 118, respectively, and prevents having to advance the primary and secondary pistons 116 and 118, respectively, over a relatively large distance without any increase in pressure in the non-failed circuit. For example, if the service brake system 100 is under the manual push through mode and, additionally, fluid pressure is lost in the output circuit relative to the secondary piston 118, such as for example in the secondary output conduit 138, the secondary piston 118 will be forced or biased in the rightward direction due to the pressure within the primary output pressure chamber 142.

If the primary and secondary pistons 116 and 118, respectively, were not connected together, the secondary piston 118 would freely travel to its further most right-hand position, as viewing FIG. 1, and the driver would have to depress the service brake pedal 120 a distance to compensate for this loss in travel. However, because the primary and secondary pistons 116 and 118, respectively, are connected together through a locking member, the secondary piston 118 is prevented from this movement and relatively little loss of travel occurs in this type of failure. Thus, the maximum volume of the primary output pressure chamber 142 is limited had the secondary piston 118 not been connected to the primary piston 116.

In another example, if the service brake system 100 is under the manual push through mode and, additionally, fluid pressure is lost in the output circuit relative to the primary piston 116, such as for example, in the primary output conduit 136, the secondary piston 118 will be forced or biased in the leftward direction due to the pressure within the secondary output pressure chamber 140. Due to the configuration of the brake pedal unit 112, the left-hand end of the secondary piston 118 is relatively close to the right-hand end of the primary piston 116. Thus, movement of the secondary piston 118 towards the primary piston 116 during this loss of pressure is reduced compared to a conventional master cylinder in which the primary and secondary pistons 116 and 118, respectively, have equal diameters and are slidably disposed in the same diameter bore. To accomplish this advantage, the housing of the brake pedal unit 112 includes a stepped bore arrangement such that a diameter of the second bore which houses the primary piston 116 is larger than the third bore housing the secondary piston 118. A portion of the primary output pressure chamber 142 includes an annular region surrounding a left-hand portion of the secondary piston 118 such that the primary and secondary pistons 116 and 118, respectively, can remain relatively close to one another during a manual push through operation.

In the configuration shown, the primary and secondary pistons 116 and 118, respectively, travel together during a manual push through operation in which both of the circuits corresponding to the primary and secondary output conduits 136 and 138, respectively, are intact. This same travel speed is due to the hydraulic effective areas of the primary and secondary pistons 116 and 118, respectively, for their respective primary and secondary output pressure chambers 142 and 140, respectively, being approximately equal. In a preferred embodiment, the area of the diameter of the secondary piston 118 is approximately equal to the area of the diameter of the primary piston 116 minus the area of the diameter of the secondary piston 118. Of course, the brake pedal unit 112 could be configured differently such that the primary and secondary pistons 116 and 118, respectively, travel at different speeds and distances during a manual push through operation.

Referring now to FIG. 2, the third wheel brake 106C is illustrated in detail with the first actuator 208 of the first EPB 206A. Discussion of the third wheel brake 106C and the first actuator 208 also applies to the fourth wheel brake 106D with the second actuator 210 of the second EPB 206B and any other EPB's that may be provided. Furthermore, discussion of the third wheel brake 106C without the first actuator 208 also applies to the first and second wheel brakes 106A and 106B, respectively. Together, the third wheel brake 106C and first actuator 208 comprise a disc brake arrangement, indicated generally at 300.

The third wheel brake 106C comprises the brake caliper assembly 302, which is mounted in a floating manner by means of a brake carrier (not shown) in a known manner, and which spans the brake rotor 304 that is coupled to the vehicle wheel in a rotationally fixed manner. Provided in the brake caliper assembly 302 is a brake pad arrangement, which has a first brake pad 306 that bears on the brake caliper assembly 302 and a second brake pad 308 that bears on the brake piston 310. The first and second brake pads 306 and 308, respectively, face towards each other and, in the release position shown, are disposed with a small air clearance on both sides of the brake rotor 304, such that no significant braking force or other residual drag moments occur. By means of a brake pad carrier 310, the second brake pad 308 is disposed on the brake piston 310, for the purpose of moving jointly. The brake piston 310 is mounted in a movable manner in a fluid cavity 312 in the brake caliper assembly 302. The third wheel brake 106C may be hydraulically actuated via the brake pedal 120 by the driver or via the hydraulic control unit 104. The third wheel brake 106C is hydraulically actuated by operating the third apply valve 174 to supply fluid pressure to the fluid cavity 312 via a conduit 314. The fluid pressure displaces the brake piston 310 leftward in FIG. 2 such that the first and second brake pads 306 and 308, respectively (the first brake pad 306 via the brake caliper assembly 302) engage the brake rotor 304.

In addition, it can be seen in FIG. 2 that the brake piston 310 is realized so as to be hollow. Accommodated in the brake piston 310 is a thrust piece 316 of the first actuator 208. The first actuator 208 further comprises a drive assembly 318 having an electric motor and a transmission arrangement. An output shaft 320 of the drive assembly 318 drives a drive spindle 322, which is supported via an axial bearing 324 and which is accommodated in a threaded manner in a threaded receiver 326 of the thrust piece 316.

In its region that is on the left and that faces towards the brake rotor 304 in FIG. 2, the thrust piece 316 has a conical portion 328, which can be brought into bearing contact with a complementarily conical inner surface 330 of the brake piston 310. In the release position shown in FIG. 2, there is a clearance 332 between the two conical faces 328 and 330. Thus, the clearance 332 is between the actuator 208 and the brake piston 310.

The parking brake ECU 218 (shown in FIG. 1) controls operation of the first and second EPB's 206A and 206B, respectively. When the first EPB 206A is normally applied, the brake piston 310 of the third wheel brake 106C is displaced by fluid pressure (via the service brake system 100) such that the first and second brake pads 306 and 308, respectively, of the third wheel brake 106C are pressed into engagement with the brake rotor 304 mounted on the associated wheel. Thus, the brake piston 310 comprises a hydraulic actuating mechanism. Subsequently, the first actuator 208 is operated such that the brake piston 310 is supported on the first actuator 208 against the brake rotor 304. The fluid pressure may then be removed and the brake piston 310 remains supported on the first actuator 208. Thus, the first and second actuators 208 and 210, respectively, comprise an electric actuating mechanism. When the first EPB 206A is normally released, the fluid pressure is reapplied (if removed during application of the first EPB 206A), the first actuator 208 is operated such that the brake piston 310 is no longer supported on the first actuator 208, and the fluid pressure is then released to allow the first and second brake pads 306 and 308, respectively, to release from the brake rotor 304. Alternatively, the first actuator 208 may be operated for the brake piston 310 to be supported on the first actuator 208 against the brake rotor 304 without the brake piston 310 being first displaced by fluid pressure. Normal operation of the second EPB 206B is similar to the first EPB 206A.

The first and second actuators 208 and 210, respectively, each produce a variable torque amount. As the torque amount increases, a braking force produced by the first and second EPB's 206A and 206B, respectively, also increases and, as the torque amount decreases, the braking force produced by the first and second EPB's 206A and 206B, respectively, also decreases. Thus, each of the first and second EPB's 206A and 206B, respectively, may be applied or released by degrees between fully released and fully applied. The first and second actuators 208 and 210, respectively, may be controlled independently such that each of the first and second EPB's 206A and 206B, respectively, produces a different braking force.

The parking brake ECU 218 may control the first and second EPB's 206A and 206B, respectively, in response to the parking brake manual control 220 (shown in FIG. 1). As non-limiting examples, the parking brake input manual control 220 may be a button, switch, or lever by which the driver of the vehicle applies or releases the first and second EPB's 206A and 206B, respectively.

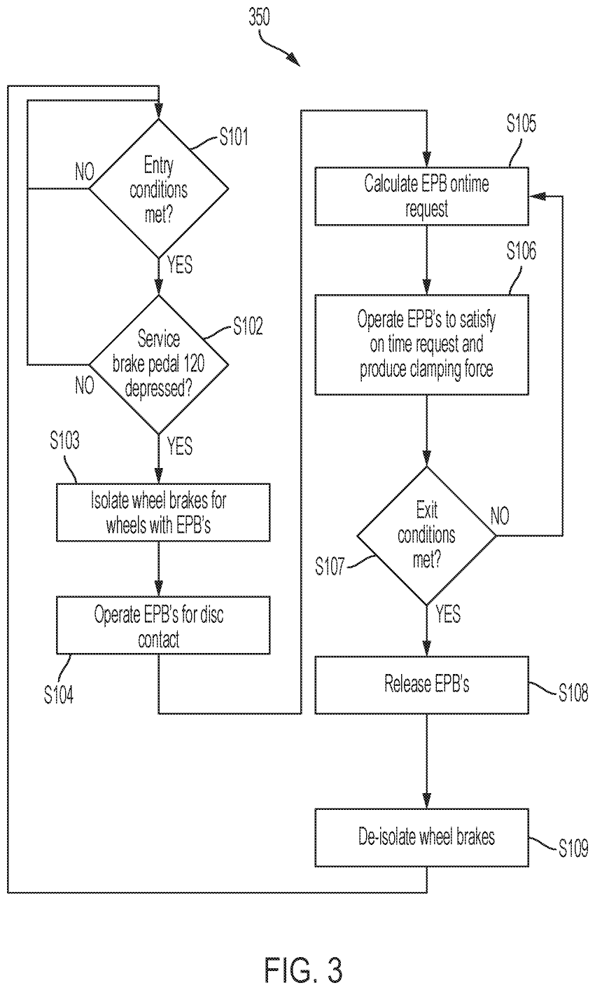

Referring now to FIG. 3, there is illustrated a first embodiment of a control method, indicated generally at 350, for the service brake system 100 and the first and second EPB's 206A and 206B, respectively. The control method 350 operates the first and second EPB's 206A and 206B, respectively, to provide deceleration for the vehicle—i.e., braking—in response to the service braking demand made with the service brake pedal 120. The control method 350 limits travel of the service brake pedal 120 during certain failed boost scenarios. The control method 350 is preferably performed when the system status indicates the failure condition. Thus, the control method 350 bypasses the parking brake ECU 218.

In a step S101, the control method 350 checks that entry conditions are met. The entry conditions preferably include, but are not limited to, that the system status sensor 204 indicates the failure condition for the service brake system 100, the first and second EPB's 206A and 206B, respectively, are operating correctly, the first and third dump valves 164 and 176, respectively, remain operable and controllable to isolate the third and fourth wheel brakes 106C and 106D, respectively, and the first and second pressure transducers 148 and 150, respectively, are responsive. As discussed, the failure condition may be that the service brake system 100 is operating in the push through mode with failed boost. Typically, this is the result of a failure of the motor 196. When the entry conditions are met, the control method 350 proceeds to a step S102. When the entry conditions are not met, the control method 350 repeats the step S101 until the entry conditions are met. Preferably, the entry conditions are checked throughout the control method 350 and the control method 350 aborts if the entry conditions are no longer met.

In the step S102, the control method 350 checks if the service brake pedal 120 is being depressed or there is otherwise an initial braking command to operate the first and second EPB's 206A and 206B, respectively. Preferably, the step S102 checks whether the service brake pedal 120 is being depressed greater than a minimum travel amount. When the service brake pedal 120 is being depressed, the control method 350 proceeds to a step S103. When the service brake pedal 120 is not being depressed, the control method 350 returns to the step S101. A time duration may be set after which, if the service brake pedal 120 is not depressed, the control method 350 returns to the step S101. Alternatively, the step S102 may repeat until the service brake pedal 120 is depressed.

With the entry conditions met and the service brake pedal 120 being depressed, in the step S103, the third and fourth wheel brakes 106C and 106D, respectively, with the first and second EPB's 206A and 206B, respectively, are isolated—e.g., hydraulically isolated. Isolating the third and fourth wheel brakes 106C and 106D, respectively, reserves fluid pressure solely. This will result in less travel of the service brake pedal 120 than would otherwise result from a four wheel push through mode.

As illustrated, isolating the third and fourth wheel brakes 106C and 106D, respectively, entails the third and fourth wheel brakes 106C and 106D, respectively, being isolated. As discussed, the third wheel brake 106C is isolated by closing the third apply valve 174 and the third dump valve 176. Similarly, the fourth wheel brake 106D is isolated by closing the fourth apply valve 180 and the fourth dump valve 182. Isolation of the third and fourth wheel brakes 106C and 106D, respectively, redirects the fluid pressure of the brake system 100 to the first and second wheel brakes 106A and 106B, respectively—i.e., the service brake system 100 operates in two wheel push through.

In a step S104, the first and second actuators 208 and 210, respectively, are operated so that the brake pad 308 contacts the brake rotor 304, but without the brake pad 308 being applied to the brake rotor 304 to provide or otherwise develop any significant braking force.

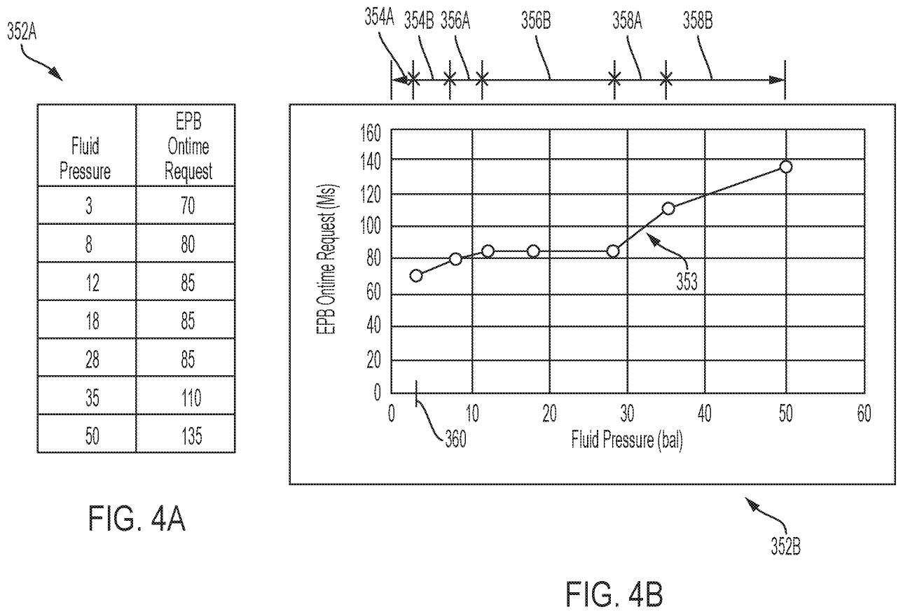

In a step S105, an ontime request value is calculated as a function of the fluid pressure of the service brake system 100. The ontime request value is a time duration for actuating the first and second EPB's 206A and 206B, respectively. As a non-limiting example, the ontime request value may be calculated as a function of the fluid pressure in a master cylinder. Calculation of the ontime request value will be discussed further with respect to FIGS. 4A and 4B.

In a step S106, the first and second EPB's 206A and 206B, respectively, are operated to satisfy the ontime request value—i.e., the first and second EPB's 206A and 206B, respectively, are operated for the time duration that equals or otherwise satisfies the ontime request value. As a result, the first and second EPB's 206A and 206B, respectively develop a clamping force on the brake rotor 304 such that the first EPB 206A is supported by the first actuator 208 and the second EPB 206B is supported by the second actuator 210. This braking force provides deceleration for the rear wheels of the vehicle.

In a step S107, a check is made if exit conditions for the control method 350 have been met. As a non-limiting example, the exit conditions may comprise the driver releasing the service brake pedal 120. When the exit conditions have not been met, then the control method 350 returns to the step S105. When the exit conditions are met, then the control method 350 proceeds to a step S108.

In the step S108, the first and second EPB's 206A and 206B, respectively, are released. When the first and second EPB's 206A and 206B, respectively, are fully released, the first and second actuators 208 and 210, respectively, are preferably operated until the feedback currents are less than a post run current threshold to ensure that the first and second actuators 208 and 210, respectively, are fully disengaged from the brake pistons 310.

Then, in a step S109, the wheel brakes with electric parking brakes are de-isolated. As illustrated, this entails the third and fourth wheel brakes 106C and 106D, respectively, being de-isolated. The third wheel brake 106C is de-isolated by opening the third apply valve 174 or the third dump valve 176, as required by operation of the service brake system 100. Similarly, the fourth wheel brake 106D is de-isolated by opening the fourth apply valve 180 or the fourth dump valve 182, again as required by operation of the service brake system 100. Following the step S109, the control method 350 returns to the step S101.

As discussed, the control method 350 provides deceleration when the system status sensor 204 indicates a failure condition for the service brake system 100—i.e., the service brake system 100 is operating in the push through mode. Alternatively, the control method 350 may operate the first and second EPB's 206A and 206B, respectively, to provide deceleration that supplements braking provided by the service brake system 100 when there is no failure condition—i.e., when the service brake system 100 is operating normally. Alternatively, the control method 350 may operate the first and second EPB's 206A and 206B, respectively, to provide deceleration that supplements other braking, such as engine braking. The control method 350 may operate the first and second EPB's 206A and 206B, respectively, to provide deceleration that supplements engine braking when the service brake system 100 is operating in the push through mode or normally.

Referring now to FIGS. 4A and 4B, calculation of the ontime request value for the control method 350 will be discussed. The calculation of the ontime request value in FIGS. 4A and 4B may be incorporated into the control method 350. For example, the ontime request value as calculated in FIGS. 4A and 4B may be incorporated into the step S105 of the control method 350.

As a non-limiting example, the ontime request value may be calculated as a function of the fluid pressure. In FIGS. 4A and 4B, a table, indicated generally at 352A, and a graph, indicated generally at 352B, illustrate a relationship between the fluid pressure of the service brake system 100 and the ontime request value. The graph 352B illustrates an actuating time curve, indicated generally at 353, for the first and second EPB's 206A and 206B, respectively. The ontime request values are calibrated to the fluid pressure. Such calibration is preferably performed on a high mu surface with various applications of the service brake pedal 120. Braking performance is balanced against excessive release activity on high and mid mu surfaces.

Generally, as the fluid pressure increases (indicating increased application of the non-isolated first and second wheel brakes 106A and 106B, respectively), the ontime request value also increases. Thus, the braking at the rear wheels provided by the first and second EPB's 206A and 206B, respectively, is correlated with braking at the front wheels by the service brake system 100. The relationship between the fluid pressure and the ontime request value will be discussed further in detail. When the failure condition indicates a failure of the service brake system 100 and the fluid pressure is at or below a threshold, then the control method 350 may be stopped and the four wheel push through used for the brake system 100.

The ontime request value does not increase in direct proportion to the fluid pressure. In first and second ranges 354A and 354B, respectively, the ontime request value increases as the fluid pressure increases, then in third and fourth ranges 356A and 356B, respectively, the ontime request value is constant while the fluid pressure continues to increase, and lastly in fifth and sixth ranges 358A and 358B, respectively, the ontime request value again increases as the fluid pressure increases. The ontime request value being kept constant in the third and fourth ranges 356A and 356B, respectively, reduces a likelihood of the vehicle experiencing overly aggressive braking that may lead to a “porpoise” motion for the vehicle. As illustrated, a first gain is applied in calculating the ontime request value for the first range 354A, a second gain is applied in calculating the ontime request value for the second range 354B, a third gain is applied in calculating the ontime request value for the fifth range 358A, and a fourth gain value is applied for calculating the ontime request value for the sixth range 358B. Further as illustrated, the first gain is greater than the second gain and the third gain is greater than the fourth gain. Alternatively, the first and second gains may be equal and the third and fourth gains may be equal (such that the ontime request value would increase linearly in the first, second, fifth, and sixth ranges 354A, 354B, 358A, and 358B, respectively). Furthermore, below a minimum fluid pressure 360, the ontime request value is set to zero. As illustrated, the minimum fluid pressure 360 is 3 bar.

The fluid pressure may be restricted to discrete magnitudes or jumps so that only meaningful changes in the fluid pressure create a reaction—i.e., calculation of the ontime request value. As a non-limiting example, the fluid pressure may be restricted to discrete 5 bar magnitudes or jumps. In such a case, the fluid pressure must change at least 5 bar before a new ontime request value is calculated. Smaller magnitude values increase apply and release sensitivity to changes in the fluid pressure. Larger magnitude values would requires more fluid pressure before a reaction is generated—i.e., the ontime request value is calculated.

Alternatively, instead of the fluid pressure, a length measurement of pedal travel may be used to calculate the ontime request value. As a non-limiting example, measured movement of the input rod 122 may be used to calculate the ontime request value. Alternatively, the measured movement of the input rod 122 may be used to check, verify, or otherwise validate the ontime request value calculated as a function of the fluid pressure. The measured movement of the input rod 122 may also be used to calculate the ontime request value when the fluid pressure in unavailable—e.g., the first and second transducers 148 or 150, respectively, are non-responsive. Alternatively, the ontime request value may be calculated as a function of a brake pedal force applied by the driver at the service brake pedal 120. Alternatively, the ontime request value may be calculated as a function of a fluid pressure in the plunger assembly 152.

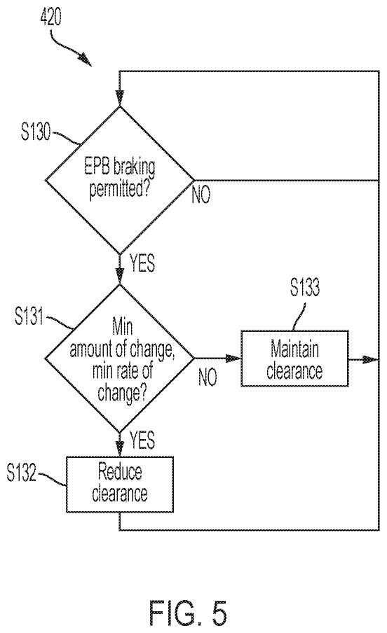

Referring now to FIG. 5, there is illustrated a clearance reducing method, indicated generally at 420, for the control method 350 to reduce the clearance 332. The clearances 332 between the brake piston 310 of the third wheel brake 106C and the first actuator 208 and between the brake piston 310 of the fourth wheel brake 106D and the second actuator 210 may be reduced when a throttle input sensor 222 (shown in FIG. 1) indicates both an amount of change for the throttle input is greater than a minimum amount of change and a rate of change for a throttle input of the vehicle is greater than a minimum rate of change. Alternatively, the clearances 322 may instead be reduced on a full release of the throttle input. For the clearance reducing method 420, the amount of change and the rate of change indicate that the throttle input is being reduced—i.e., the throttle pedal is being released. The clearance reducing method 420 may be incorporated into the control method 350. For example, the clearance reducing method 420 may be performed prior to operation of the first and second EPB's 206A and 206B, respectively, in the step S204. Alternatively, the clearance reducing method 420 may be omitted from the control method 350.

In a step S130, the clearance reducing method 420 verifies that the control method 350 is permitting the first and second EPB's 206A and 206B, respectively, to operate and provide deceleration for the vehicle. As a non-limiting example, the step S130 may check that the step S101 in FIG. 3 is true. Alternatively, the step S130 may be omitted from the clearance reducing method 420.

Next, in a step S131, the clearance reducing method 420 checks whether the amount of change for the throttle input is greater than the minimum amount of change and the rate of change for a throttle input of the vehicle is greater than the minimum rate of change. In a step S132, when the amount of change for the throttle input is greater than the minimum amount of change and the rate of change for a throttle input of the vehicle is greater than the minimum rate of change, the first and second actuators 208 and 210, respectively, may be operated to reduce the clearance 332. As will be discussed, the clearance 332 may be reduced to zero such that the conical faces 328 and 330 contact, but without the brake pad 308 being applied to the brake rotor 304. Furthermore, when the amount of change for the throttle input is greater than the minimum amount of change and the rate of change for a throttle input of the vehicle is greater than the minimum rate of change, the vehicle is travelling in a substantially straight line, and the brake system 100 is experiencing the failure condition, the first and second actuators 208 and 210, respectively, may be operated so that the brake pad 308 contacts the brake rotor 304, but without the brake pad 308 being applied to the brake rotor 304 to provide or otherwise develop any significant braking force. Preferably, the brake pad 308 is applied to the brake rotor 304 without any braking force being developed.

The clearance 332 is reduced in the step S132 without a braking demand being made at the service brake pedal 120—i.e., the braking demand at the service brake pedal 120 is zero during the step S132. Thus, the clearance 332 is not reduced in the step S132 such that the first and second brake pads 306 and 308, respectively, engage with the brake rotor 304 to provide any significant braking force. Preferably, the clearance 332 is reduced in the step S132 without providing any braking force. When the clearance 332 is zero, the brake piston 310 is in contact with the first brake pad 306, via the caliper assembly 302, and the second brake pad 308, but the first and second brake pads 306 and 308, respectively, are not engaged with the brake rotor 304 so as to provide any significant braking force. Preferably, when the clearance 332 is zero, no braking force is produced. Reducing the clearance 332 reduces time required for the actuator 310 to subsequently engage the first and second brake pads 306 and 308, respectively, with the brake rotor 304 to provide the braking force. The brake piston 310 being in contact with the first and second brake pads 306 and 308, respectively, may be determined by monitoring the feedback currents of the first and second actuators 208 and 210, respectively.

After a time duration, when the driver has not applied the brake pedal 120 or the throttle input returns to the apply state, the first and second actuators 208 and 210, respectively, retract to reestablish the clearance 332. As a non-limiting example, the time duration may be calibrated to three seconds.

In a step 133, when the amount of change for the throttle input is greater than the minimum amount of change and the rate of change for a throttle input of the vehicle is greater than the minimum rate of change, the clearance 332 is maintained in its current state and not changed or otherwise altered by the clearance reducing method 420.

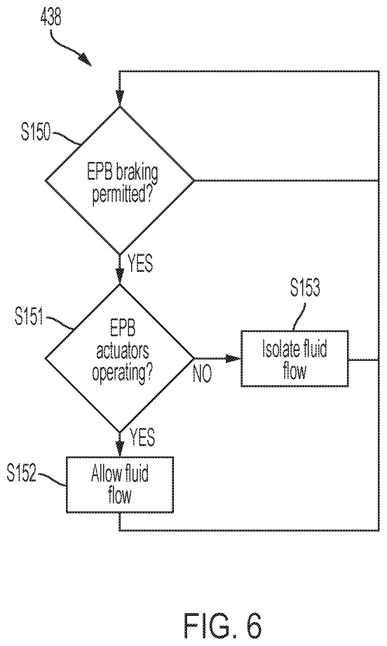

Referring now to FIG. 6, there is illustrated a pressure release method, indicated generally at 438, for the control method 350. The pressure release method 438 may be incorporated into the control method 350. For example, the pressure release method 438 may be incorporated into the step S106 that operates the first and second EPB's 206A and 206B, respectively, to satisfy the ontime request and produce the clamping force.

In a step S150, the pressure release method 438 verifies that the control method 350 is permitting the first and second EPB's 206A and 206B, respectively, to operate and provide deceleration for the vehicle. As a non-limiting example, the step S150 may check that the step S101 in FIG. 3 is true. Alternatively, the step S150 may be omitted from the pressure release method 438.

In a step S151, the pressure release method 438 determines whether either of the first or second actuators 208 or 210, respectively, is operating. In a step S152, when the torque amount produced by the first and second actuators 208 and 210, respectively, is increased or decreased—i.e., the first or second actuator 208 or 210, respectively, is operating or otherwise moving, then fluid pressure is allowed to flow between the fluid cavity 312 and the fluid reservoir 108, respectively—i.e., fluid pressure is supplied or relieved. As a non-limiting example, the fluid pressure flow may be allowed between the third and fourth wheel brakes 106C and 106D, respectively, by reopening the closed first and third dump valves 164 and 176, respectively, when the first and second actuators 208 and 210, respectively are operated to increase or decrease the torque amount. The first dump valve 164 is reopened when the second actuator 210 is operated and the third dump valve 176 is reopened when the first actuator 208 is operated. In a step S153, when the torque amount produced by the first and second actuators 208 and 210, respectively, is not increased or decreased—i.e., the torque amount is maintained constant and the first or second actuator 208 or 210, respectively, are not operating or moving, then the third and fourth wheel brakes 106C and 106D, respectively, with the first and second EPB's 206A and 206B, respectively, are maintained isolated.

Feedback currents may be used to determine whether the first or second actuator 208 or 210, respectively, is moving. When a first feedback current for the first actuator 208 is greater than an idle or other minimum current, then the first actuator 208 is considered to be moving and the first dump valve 164 is reopened while the first feedback current is greater than the idle current. The first actuator 208 is considered to have stopped and not be moving when the first feedback current is less than or equal to the idle current. The first dump valve 164 is closed while the first actuator 208 is not moving. Similarly, when a second feedback current for the second actuator 210 is greater than the idle or other minimum current, then the second actuator 210 is considered to be moving and the third dump valve 176 is reopened while the second feedback current is greater than the idle current. The second actuator 210 is considered to have stopped and not be moving when the second feedback current is less than or equal to the idle current. The third dump valve 176 is closed while the second actuator 210 is not moving.

Only movement of the first or second actuator 208 or 210, respectively, is considered during the pressure release method 438 to determine whether to reopen the first or third dump valves 164 or 176, respectively. A direction of the movement—e.g., forward or reverse—of the first or second actuator 208 or 210, respectively, is not considered during the pressure release method 438. The first or third dump valves 164 or 176, respectively, are reopened when the first or second actuator 208 or 210, respectively, are operated to move in any direction—e.g., forward or reverse.

Pairing the reopening of the first and third dump valves 164 and 176, respectively, to operation of the first and second actuators 208 and 210, respectively, so that the first and third dump valves 164 and 176, respectively, are only reopened when the first and second actuators 208 and 210, respectively, are operated may be desirable to avoid overheating of the first and third dump valves 164 and 176, respectively. Alternatively, the first and third dump valves 164 and 176, respectively, may be opened for less than a full time the first and second actuators 208 and 210, respectively, are operated. Alternatively, the first and third dump valves 164 and 176, respectively, may be maintained open during the step S106 of the control method 350.

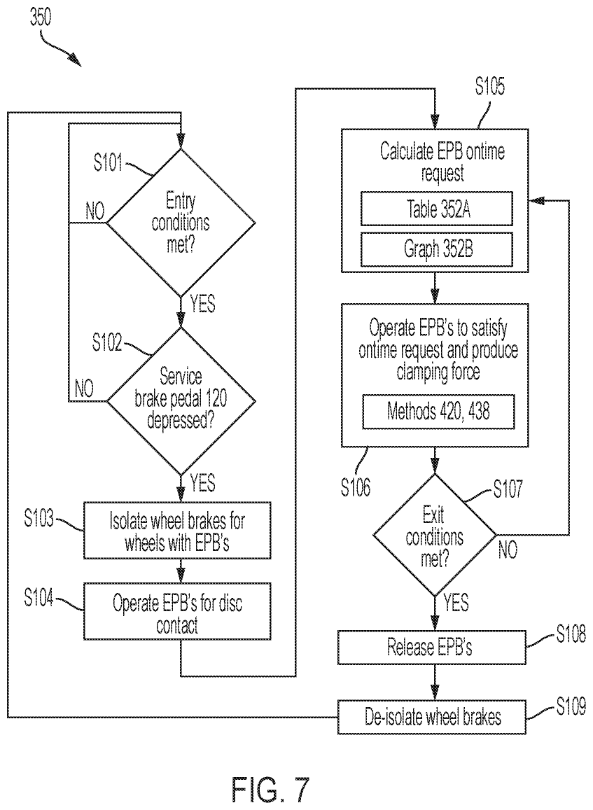

The clearance reducing method 420, the equivalent brake pressure calculations of FIGS. 4A and 4B, and the pressure release method 438, may be selectively incorporated into the control method 350. For example, all of the clearance reducing method 420, the equivalent brake pressure calculations of FIGS. 4A and 4B, and the pressure release method 438, may be incorporated into the control method 350. FIG. 7 illustrates the control method 350 with all of the clearance reducing method 420, the equivalent brake pressure calculations of FIGS. 4A and 4B, and the pressure release method 438 incorporated. Alternatively, none of the clearance reducing method 420, the specific equivalent brake pressure calculations of FIGS. 4A and 4B, and the pressure release method 438 may be incorporated into the control method 350. Alternatively, some combination of less than all of the clearance reducing method 420, the equivalent brake pressure calculations of 4A and 4B, and the pressure release method 438, respectively, may be incorporated into the control method 350.

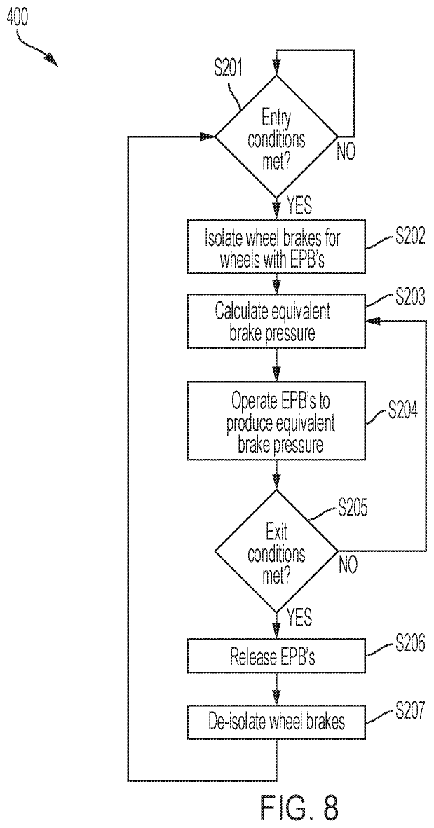

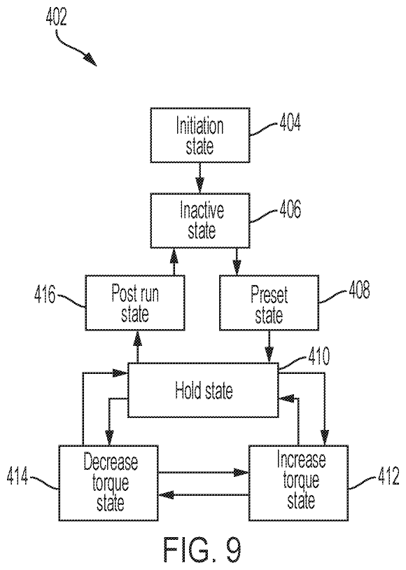

Referring now to FIGS. 8 and 9, there is illustrated a second embodiment of a control method, indicated generally at 400, and a state diagram, indicated generally at 402 for the service brake system 100 and the first and second EPB's 206A and 206B, respectively. The state diagram 402 illustrates relationships between operational states for each of the first and second EPB's 206A and 206B, respectively, during the control method 400.

The control method 400 operates the first and second EPB's 206A and 206B, respectively, to provide deceleration for the vehicle—i.e., braking—in response to the service braking demand made with the service brake pedal 120. The control method 400 is preferably performed when the system status indicates the failure condition. Thus, the control method 400 bypasses the parking brake ECU 218.

The first and second EPB's 206A and 206B, respectively, change from an initiation state 404 to an inactive state 406 when the control method 400 has initiated. The control method 400 may initiate at key on for the vehicle.

In a step S201, the control method 400 checks that entry conditions are met. The entry conditions include that the system status sensor 204 indicates the failure condition for the service brake system 100, the first and second EPB's 206A and 206B, respectively, are operating correctly, and the first and third dump valves 164 and 176, respectively, remain operable and controllable to isolate the third and fourth wheel brakes 106C and 106D, respectively. As discussed, the failure condition may be that the service brake system 100 is operating in the push through mode. Typically, this is the result of a failure of the motor 196. Other entry conditions may include the driver depressing the service brake pedal 120 to show a braking intent. When the entry conditions are met, the first and second EPB's 206A and 206B, respectively, change to a preset state 408 and the control method 400 proceeds to a step S202. When the entry conditions are not met, the control method 400 repeats the step S201 until the entry conditions are met.

With the entry conditions met, in the step S202, the third and fourth wheel brakes 106C and 106D, respectively, with the first and second EPB's 206A and 206B, respectively, are isolated. Preferably, the first and second EPB's 206A and 206B, respectively, are isolated when the switch 146 detects a minimum travel amount of the service brake pedal 120. As illustrated, this entails the third and fourth wheel brakes 106C and 106D, respectively, being isolated. As discussed, the third wheel brake 106C is isolated by closing the third apply valve 174 and the third dump valve 176. Similarly, the fourth wheel brake 106D is isolated by closing the fourth apply valve 180 and the fourth dump valve 182. Isolation of the third and fourth wheel brakes 106C and 106D, respectively, redirects the fluid pressure of the brake system 100 to the first and second wheel brakes 106A and 106B, respectively—i.e., the service brake system 100 operates in two wheel push through.

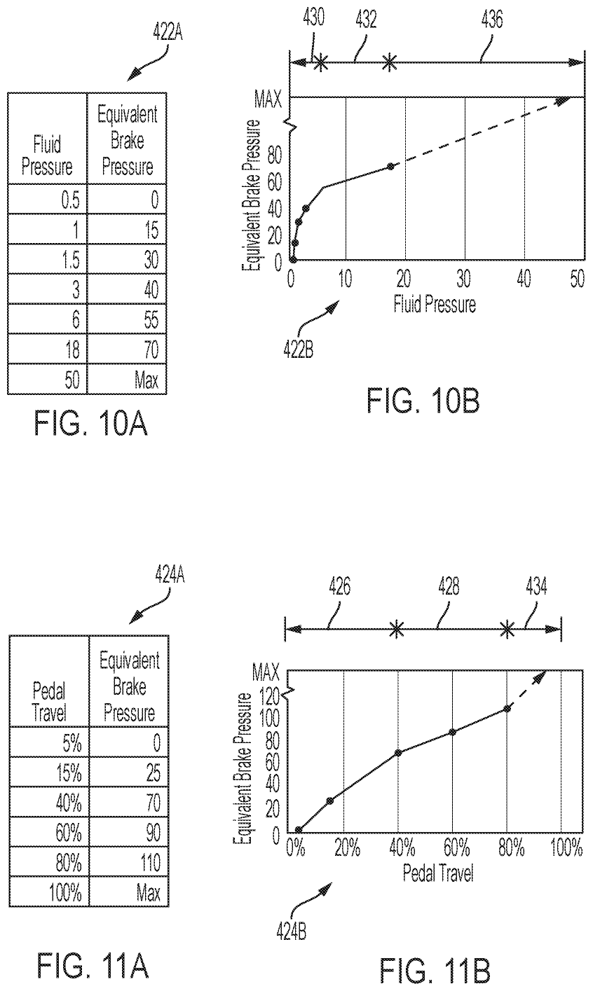

In a step S203, an equivalent brake pressure is calculated as a function of the service braking demand—i.e., the equivalent brake pressure is mapped to the service braking demand. Preferably, the equivalent brake pressure is calculated as a function of the fluid pressure. Alternatively, the equivalent brake pressure may be calculated as a function of pedal travel at the service brake pedal 120 or as some other function. Calculation of the equivalent brake pressure will be discussed further with respect to FIGS. 10A-11B.

In a step S204, the first and second EPB's 206A and 206B, respectively, are operated to produce the equivalent brake pressure. Specifically, the first and second actuators 208 and 210, respectively, are operated to apply the first and second EPB's 206A and 206B, respectively. The first and second actuators 208 and 210, respectively, are operated to eliminate the clearance 332 and place the brake piston 310 in contact with the first brake pad 306, via the caliper assembly 302, and the second brake pad 308 (by displacing the brake piston 310 leftward in FIG. 2), such that the first and second brake pads 306 and 308, respectively, engage with the brake rotor 304 to provide a braking force. As a result, the first EPB 206A is supported by the first actuator 208 and the second EPB 206B is supported by the second actuator 210.

In the preset state 408, before the first and second EPB's 206A and 206B, respectively, are operated in the step S204, the first and second actuators 208 and 210, respectively, are synchronized to a common starting position. The first and second actuators 208 and 210, respectively, may be synchronized by operating the first and second actuators 208 and 210, respectively, until feedback currents from each of the first and second actuators 208 and 210, respectively, are equal. Once the feedback currents are equal, the first and second actuators 208 and 210, respectively, will produce equal amounts of torque because the torque amount produced by the first and second actuators 208 and 210, respectively, is proportional to the feedback currents. A timer may be used to delay measurement of the feedback current to allow in-rush current to settle. For example, the timer may be for 120 ms.

In the step S204, a check is made if the torque amount produced by the first and second actuators 208 and 210, respectively, is to be decreased, increased, or held constant to produce the equivalent brake pressure. As shown in FIG. 9, the first and second EPB's 206A and 206B, respectively, each have a hold state 410, an increase torque state 412, and a decrease torque state 414.

The first and second EPB's 206A and 206B, respectively, change from the hold state 410 to an increase torque state 412 when the equivalent brake pressure is greater than an upper brake pressure threshold. In the increase torque state 412, the first and second actuators 208 and 210, respectively, are operated to be applied and increase the torque amount produced by the first and second actuators 208 and 210, respectively. The first and second EPB's 206A and 206B, respectively, change from the hold state 410 to a decrease torque state 414 when the equivalent brake pressure is less than a lower brake pressure threshold. In the decrease torque state 414, the first and second actuators 208 and 210, respectively, are operated to be released and decrease the torque amount produced by the first and second actuators 208 and 210, respectively. The first and second EPB's 206A and 206B, respectively, change from the increase torque state 412 to the decrease torque state 414 when the equivalent brake pressure is less than the lower brake pressure threshold and from the decrease torque state 414 to the increase torque state 412 when the equivalent brake pressure is greater than the upper brake pressure threshold. The first and second EPB's 206A and 206B, respectively, change from the increase torque state 412 to the hold state 410, or from the decrease torque state 414 to the hold state 410, once the first and second EPB's 206A and 206B, respectively, produce the equivalent brake pressure. In the hold state 410, the first and second actuators 208 and 210, respectively, are operated to be held and maintain the torque amount the first and second actuators 208 and 210, respectively, are currently producing.

The upper brake pressure threshold is for application (or partial application) of the first and second EPB's 206A and 206B, respectively, and the lower brake pressure threshold is for release (or partial release) of the first and second EPB's 206A and 206B, respectively. The upper and lower brake pressure thresholds are set from prior operation of the first and second actuators 208 and 210, respectively, for the first and second EPB's 206A and 206B, respectively, to produce a prior equivalent brake pressure. The prior operation is from when the first and second actuators 208 and 210, respectively, were last energized before the control method 400 commenced. The first and second actuators 208 and 210, respectively, may have been last energized during a prior performance of the control method 400 or during normal operation of the first and second EPB's 206A and 206B, respectively, to provide the parking brake function for the vehicle.

The upper brake pressure threshold is greater than the prior equivalent brake pressure and the lower brake pressure threshold is less than the prior equivalent brake pressure. The upper and lower brake pressure thresholds may be calibrated. For example, the upper brake pressure threshold may be 5 bar greater than the prior equivalent brake pressure and the lower brake pressure threshold may be 5 bar less than the prior equivalent brake pressure. The upper and lower brake pressure thresholds reduce hysteresis for the control method 400.

The first and second actuators 208 and 210, respectively, may be operated to produce the equal torque amounts. Alternatively, the first and second actuators 208 and 210, respectively, may be operated to produce unequal torque amounts.

Although operation of the first and second actuators 208 and 210, respectively, by the control method 400 has been described in tandem, the control method 400 may alternatively operate the first and second actuators 208 and 210, respectively, independently. For example, the control method 400 may operate one of the first and second actuators 208 and 210, respectively, to increase a first torque amount while the other of the first and second actuators 208 and 210, respectively, is operated to decrease a second torque amount, wherein a sum of the first and second torque amounts is the torque amount to produce the equivalent brake pressure.

In the step S205, a check is made if exit conditions for the control method 400 have been met. As a non-limiting example, the exit conditions may comprise the driver releasing the service brake pedal 120. When the exit conditions have not been met, then the control method 400 returns to the step S203. When the exit conditions are met, then the control method 400 proceeds to a step S206.

In the step S206, the first and second EPB's 206A and 206B, respectively, are released. The first and second EPB's 206A and 206B, respectively, enter the post run state 416 when the equivalent brake pressure is less than a post run brake pressure threshold. For example, the post run brake pressure threshold may be 2.5 bar. When the first and second EPB's 206A and 206B, respectively, are fully released, the first and second actuators 208 and 210, respectively, are preferably operated until the feedback currents are less than a post run current threshold to ensure that the first and second actuators 208 and 210, respectively, are fully disengaged from the brake pistons 310. When the feedback currents are less than the post run current threshold, the first and second EPB's 206A and 206B, respectively, are in the inactive state 406.

Then, in a step S207, the wheel brakes with electric parking brakes are de-isolated. As illustrated, this entails the third and fourth wheel brakes 106C and 106D, respectively, being de-isolated. The third wheel brake 106C is de-isolated by opening the third apply valve 174 or the third dump valve 176, as required by operation of the service brake system 100. Similarly, the fourth wheel brake 106D is de-isolated by opening the fourth apply valve 180 or the fourth dump valve 182, again as required by operation of the service brake system 100. Following the step S207, the control method 400 returns to the step S201. The first and second EPB's 206A and 206B, respectively, then change from the post run state 416 to the inactive state 406.

As discussed, the control method 400 provides deceleration when the system status sensor 204 indicates a failure condition for the service brake system 100—i.e., the service brake system 100 is operating in the push through mode. Alternatively, the control method 400 may operate the first and second EPB's 206A and 206B, respectively, to provide deceleration that supplements braking provided by the service brake system 100 when there is no failure condition—i.e., when the service brake system 100 is operating normally. Alternatively, the control method 400 may operate the first and second EPB's 206A and 206B, respectively, to provide deceleration that supplements other braking, such as engine braking. The control method 400 may operate the first and second EPB's 206A and 206B, respectively, to provide deceleration that supplements engine braking when the service brake system 100 is operating in the push through mode or normally.

Referring now to FIGS. 10A-10B, calculation of the equivalent brake pressure for the control method 400 will be discussed. The calculation of the equivalent brake pressure in FIGS. 10A-11B may be incorporated into the control method 400. For example, the equivalent brake pressure as calculated in FIGS. 10A-11B may be incorporated into the step S203 of the control method 400.

As a first non-limiting example, the equivalent brake pressure may be calculated as a function of the fluid pressure. In FIGS. 10A and 10B, a first table, indicated generally at 422A, and a first graph, indicated generally at 422B, illustrate a first relationship between the fluid pressure of the service brake system 100 and the equivalent brake pressure. As the fluid pressure increases (indicating increased application of the non-isolated first and second wheel brakes 106A and 106B, respectively), the equivalent brake pressure also increases. When the failure condition indicates a failure of the service brake system 100 and the fluid pressure is at or below a threshold, then the control method 400 may be stopped and the four wheel push through used for the brake system 100.

As a second non-limiting example, the equivalent brake pressure may be calculated as a function of the pedal travel signal. In FIGS. 11A and 11B, a second table, indicated generally at 424A and a second graph, indicated generally at 424B, illustrate a second relationship between the pedal travel signal and the equivalent brake pressure. As the pedal travel signal increases (indicating increased travel or depression of the service brake pedal 120), the equivalent braking demand also increases. As illustrated, the second table 424A gives the equivalent brake pressure as a function of percent of pedal travel. Alternatively, the second table 424A may give the equivalent brake pressure as a length measurement of pedal travel.

Preferably, the pedal travel signal is a first source for calculating the equivalent brake pressure with the fluid pressure as a backup or second source for calculating the equivalent brake pressure when the pedal travel signal is unavailable. Additionally, the fluid pressure may be optionally used to check, verify, or otherwise validate the equivalent brake pressure calculated from the pedal travel signal. As non-limiting examples, the pedal travel signal may be unavailable when the switch 146 is non-responsive and the fluid pressure may be unavailable when the first and second pressure transducers 148 and 150, respectively, are non-responsive. Alternatively, the fluid pressure may be the first source and the pedal travel signal the backup or second source. Alternatively, other data sources may be used to calculate the equivalent brake pressure.

Furthermore, data inputs in addition to the fluid pressure or pedal travel signal may be used in calculating the equivalent brake pressure. As non-limiting examples, the equivalent brake pressure may be calculated as a function of a brake bias factor, a vehicle reference speed, a vehicle deceleration, or rear wheel slip data in addition to the fluid pressure or pedal travel signal.

The equivalent brake pressure does not increase in direct proportion to the brake demand (in the form of the fluid pressure or pedal travel signal). Instead, a first gain is applied in calculating the equivalent brake pressure for a first range 426 of the pedal travel signal (for a first range of travel of the service brake pedal 120), a second gain is applied in calculating the equivalent brake pressure for a second range 428 of the pedal travel signal (for a second range of travel of the service brake pedal 120), and the first gain is greater than the second gain. Similarly, a third gain is applied in calculating the equivalent brake pressure for a third range 430 of the fluid pressure, a fourth gain is applied in calculating the equivalent brake pressure for a fourth range 432 of the fluid pressure, and the third gain is greater than the fourth gain. The first and third gains may be equal and the second and fourth gains may be equal or a first ratio between the first and second gains may be equal to a second ratio between the third and fourth gains, although such is not necessary. Values of the pedal travel signal in the first range 426 are less than values of the pedal travel signal in the second range 428—i.e., from rest, travel of the service brake pedal 120 results in the pedal travel signal starting in the first range 426 before advancing to the second range 428. Similarly, values of the fluid pressure in the third range 430 are less than values of the fluid pressure in the fourth range 432. Lastly, in fifth and sixth ranges 434 and 436 of the pedal travel signal and fluid pressure, respectively, the equivalent brake pressure is mapped to the braking demand such that the equivalent brake pressure increases at a constant rate to a maximum equivalent brake pressure. As a non-limiting example, the maximum equivalent brake pressure may be a maximum allowable fluid pressure allowed or otherwise able to be produced by the service brake system 100.

Below a minimum equivalent brake pressure—e.g., the equivalent brake pressure for 0.5 bar for the fluid pressure in FIG. 10A or 5% for the pedal travel signal in FIG. 11A—the control method 400 is prohibited from operating the first and second EPB's 206A and 206B, respectively, to provide deceleration for the vehicle. When the failure condition indicates a failure of the service brake system 100 and the control method 400 is prohibited to operate the first and second EPB's 206A and 206B, respectively, to provide deceleration for the vehicle, then the service brake system 100 operates in the four wheel push through mode.

Thus, more braking is provided by the first and second EPB's 206A and 206B, respectively, earlier in travel of the service brake pedal 120 at the onset of braking—i.e., during the first and third ranges 426 and 430, respectively. As a result, the first and second EPB's 206A and 206B, respectively, are applied more aggressively at the onset of travel for the service brake pedal 120 then during subsequent travel of the service brake pedal 120. This reduces travel of the service brake pedal 120 to achieve the braking demand made by the driver at the service brake pedal 120.

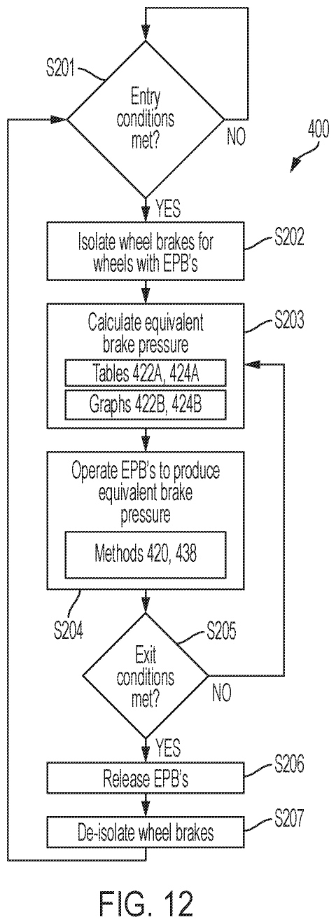

The clearance reducing method 420, the equivalent brake pressure calculations of FIGS. 10A-11B, and the pressure release method 438, may be selectively incorporated into the control method 400. For example, all of the clearance reducing method 420, the equivalent brake pressure calculations of FIGS. 10A-11B, and the pressure release method 438, may be incorporated into the control method 400. FIG. 12 illustrates the control method 400 with all of the clearance reducing method 420, the equivalent brake pressure calculations of FIGS. 10A-11B, and the pressure release method 438 incorporated. Alternatively, none of the clearance reducing method 420, the specific equivalent brake pressure calculations of FIGS. 10A-11B, and the pressure release method 438 may be incorporated into the control method 400. Alternatively, some combination of less than all of the clearance reducing method 420, the equivalent brake pressure calculations of FIGS. 10A-11B, and the pressure release method 438, respectively, may be incorporated into the control method 400.

In accordance with the provisions of the patent statutes, the principle and mode of operation of this invention have been described and illustrated in its preferred embodiment. However, it must be understood that this invention may be practiced otherwise than as specifically explained and illustrated without departing from its spirit or scope.

1. A vehicle brake system for a vehicle comprising:
a brake pedal operable by a vehicle driver and coupled to control a brake pressure generating unit to supply hydraulic brake pressure to front and rear hydraulically actuated wheel brakes, and wherein the rear wheel brakes are also configured to be electrically actuated;
a sensor arrangement for monitoring the driver's braking intent;
the brake system operable in a first mode wherein the front and rear brakes are both hydraulically actuated, and a second mode wherein the front brakes are hydraulically actuated and the rear brakes are electrically actuated,
the rear brakes include a caliper assembly including brake pads operable to engage a brake rotor to brake the vehicle, the caliper assembly including a hydraulic actuating mechanism and an electric actuating mechanism,
a control connected to the sensor arrangement for operating the electric actuating mechanism to actuate the rear brakes as a function of the driver's braking demand.

2. The brake system according to claim 1 wherein the sensor arrangement monitors brake pedal travel and the electric actuating mechanism is operated as a function of the brake pedal travel.

3. The brake system according to claim 1 wherein the sensor arrangement monitors a brake pedal force applied by the driver and/or a hydraulic pressure in the unit, and wherein the electric actuating mechanism is operated as a function of the pedal force and/or the hydraulic pressure.

4. The brake system according to claim 3 wherein the electric operating mechanism is operated according to a predetermined actuating time curve that is a function of the pedal force and/or hydraulic pressure.

5. The brake system according to claim 1 wherein the control is responsive to an initial braking command to operate the electric actuating mechanism such that the pads are moved to a disc contact position.

6. The brake system according to claim 5 wherein the initial braking command is a function of the travel of the brake pedal when initially operated by the vehicle driver.

7. The brake system according to claim 5 wherein the vehicle includes a vehicle throttle operable by the vehicle driver to control propulsion of the vehicle, and wherein the initial braking command is a function of the driver's release rate of the throttle.

8. The brake system according to claim 1 wherein the brake system includes at least one inlet or isolation valve connected to supply pressure to the hydraulic actuating mechanism, and wherein the control is operable to actuate the isolation valve when the system is in the second mode to hydraulically isolate the front brakes from the rear brakes.

9. The brake system according to claim 1 wherein the brake system includes at least one outlet or dump valve connected to relieve pressure from the hydraulic actuating mechanism, and wherein the control is operable to actuate the dump valve during at least a portion of the time the electric actuating mechanism is being operated to prevent hydraulic lock and/or vacuum pull in the hydraulic actuating mechanism.

10. The brake system according to claim 1 wherein the brake system is a brake by wire system, and wherein the first mode defines a brake by wire, boosted mode, and the second mode defines a manual push through, failed boost mode.

11. The brake system according to claim 1 wherein the electric actuating mechanism also forms part of an electric parking brake system.
